(19) United States
(12) Patent Application Publication
(10) Pub. No.: US 2018/0334170 A1
(43) Pub. Date: Nov. 22, 2018

(54) PRECONDITIONING FOR HYBRID ELECTRIC VEHICLE

(71) Applicant: FORD GLOBAL TECHNOLOGIES, LLC, Dearborn, MI (US)

(72) Inventors: Yu Liu, Novi, MI (US); Xiaoyong Wang, Novi, MI (US)

(21) Appl. No.: 15/596,562

(22) Filed: May 16, 2017

(51) Int. Cl. B60W 30/192; B60W 10/30; B60W 10/26; B60W 20/00; F01N 3/20; F01N 9/00; B60H 1/00; H01M 10/48; H01M 10/625

(52) U.S. Cl. CPC B60W 30/192; H01M 2220/20; B60W 10/26; B60W 20/00; F01N 3/2006; F01N 9/00; B60H 1/00385; B60H 1/00735; B60H 1/00764; B60H 1/00978; H01M 10/486; H01M 10/625; B60W 2510/244; B60W 2710/246; B60W 2710/30; B60W 2710/0694; B60Y 2200/92; B60Y 2306/07; B60Y 2306/05; Y10S 903/93; B60W 10/30

(57) ABSTRACT

A hybrid electric vehicle (HEV) and method of operation, which include a cabin, a battery, an emission aftertreatment catalyst, and a thermal management system coupled to a compressor and a chiller that each have cooling capacities and respective refrigerant and coolant distribution systems. The HEV also includes one or more controllers configured to precondition temperatures of the battery, cabin, and catalyst in response to a predicted vehicle start-time and/or a detected action that indicates likelihood of HEV start. The controller(s) utilize respective conditioning profiles for each of the battery, cabin, and catalyst to achieve the preconditioning temperatures at rates adjusted according to power availability from the battery and an external power source. The preconditioning is terminated upon HEV start or if the predicted start-time expires without HEV start. The HEV and method are adapted to learn from changes in actual start-times and driver actions resulting in HEV starts or no-starts.

### TECHNICAL FIELD

The disclosure relates to pre-conditioning of a battery, a cabin, and an emission aftertreatment catalyst of hybrid electric vehicles.

### BACKGROUND

In hybrid electric vehicles (HEVs), performance can be affected by the ambient environment, which can introduce undesirable temperature extremes to HEV components and system. For example, before operation, an HEV passenger cabin may be uncomfortably cold or warm in certain seasons and climates. HEVs in northern latitudes may be subjected to uncomfortably low temperatures, while those in equatorial latitudes may see uncomfortably high humidity and temperatures. These temperature extremes may affect HEVs during start-up and initial operation, and may result in less than optimal performance and duty-life-cycle of an HEV battery, an emissions aftertreatment catalyst, and other HEV components and systems. Prior attempts to control temperatures of HEV components have included predicting a driver intent to operate a battery electric vehicle and to precondition temperatures of a battery and cabin before operation. Other attempts were directed to using sensors to predict imminent HEV use, and to heat an internal combustion engine before operation. There has been a need to conserve battery charge-state, and to adapt preconditioning needs in view of changing environments and driver actions.

### SUMMARY

Hybrid, plug-in hybrid, and battery electric vehicles (HEVs, PHEVs, BEVs) include a high voltage traction battery or batteries, which can be undesirably affected by uncontrolled temperatures. During operation, battery temperatures can be managed to optimize battery performance and life span. However, prior to and during initial operation, such temperature extremes may adversely affect performance and lifespan or durability of the batteries. Such temperatures may also cause an HEV cabin to be uncomfortable to occupants until it can eventually be cooled or warmed to a comfortable temperature and humidity. Additionally, the HEVs may include an internal combustion engine (ICE) and an emissions aftertreatment system having a catalyst. The ICE and catalyst may see improved performance on HEV start-up if they are pre-conditioned with heating to improve combustion efficiency and emissions control during start-up and initial HEV operation.

The HEV, PHEV, and BEV also may include a thermal management system (TMS), which includes an engine mounted and/or an electrically operated compressor and/or chiller that are each configured with cooling capacities and coupled to refrigerant and coolant distribution subsystems. The HEV also includes one or more controllers coupled to the TMS and other HEV components, and which enable an adaptive and predictive pre-conditioning system for the batteries, cabins, ICE, catalyst, and other components. The pre-conditioning is enabled according to conditioning profiles for the HEV components, and can be adjusted in response to availability of external charging power and a battery charge-state. Additionally, pre-conditioning can be prevented when insufficient power is available from the battery or external power sources. The pre-conditioning can also be prioritized among HEV components when limited power is available, and can be terminated if predicted HEV start-up does not occur.

The adaptive system includes one or more controllers that are configured to respond to a pre-conditioning signal that includes information predicting an HEV start-time. The controller(s) then initiate pre-conditioning according to conditioning profiles of HEV components, which establish preconditioning energy and target operating temperatures, among other parameters. The pre-conditioning may also be adjusted according to environmental and HEV data (e.g., plugged-in state, state of charge, component and ambient environmental temperature, etc.). The pre-conditioning is also modified in view of learned, past driver departure and start-times and patterns thereof, and sensor or other data that indicates a likelihood of imminent HEV operation. The data and patterns are utilized to predict a likelihood of imminent operation and start-times. Preconditioning is then initiated to enable optimal and efficient operation at the outset of driving, and optimal thermal ranges as operation commences at a start-time.

In configurations and methods of operation of the disclosure, an HEV/PHEV/BEV (hereafter referred to collectively as an “HEV”) incorporates a controller that is, or controllers that are, coupled to the TMS, and configured to respond to a precondition-signal that is generated in response to, and which includes information predicting a start-time. The controller(s) monitor a charge-state of the battery and an external-power signal. The external-power signal communicates whether and how much external power is available to the HEV. The controller(s) are also configured to command the TMS to precondition temperatures of at least one of the battery, cabin, and/or catalyst according to respective conditioning profiles and the charge-state and external-power signal.

The respective conditioning profiles specify a conditioning rate and at least one target operating temperature, among other parameters, for each of the vehicle components, including the battery, cabin, and catalyst, among other components. The conditioning rates enable temperature conditioning of the components to be completed such that the target operating temperature is attained by or before the predicted start-time. In variations, the disclosure contemplates the controller(s) configured to generate the preconditioning signal when a predicted start-time is imminent in view of past start-times, and/or when driver action establishes a likelihood that a start-time is imminent. The generated preconditioning signal is generated including a state-of-charge-threshold (SoC-threshold) and corresponding to the external-power signal, which, with the charge-state and other parameters, define how much power is available to enable pre-conditioning.

When limited power or less power is available than that needed to fully power pre-conditioning to enable completed temperature conditioning by the predicted start-time, then the preconditioning signal by the controller(s), controls and prioritizes the temperature preconditioning between the battery, cabin, and catalyst according to the respective conditioning profiles. For example, the controller(s) may be configured to control and adjust the preconditioning and the respective conditioning profiles to only precondition temperature of the battery when one or more proscribed and/or predetermined conditions exist. For further example, such as when external power is unavailable, when the battery charge-state is at or below the SoC-threshold, and/or when the vehicle-start probability is too low to justify pre-conditioning on battery power alone, which may unnecessarily consume stored battery power.

For additional purposes of illustration, limited power may be required when the charge-state of the battery(ies) is/are approximately less than or equal to the SoC-threshold. The SoC-threshold may be predetermined to specify a minimum battery charge-state, below which the stored battery power is insufficient to enable pre-conditioning without available external power, and above which the stored battery power is sufficient to enable full or limited pre-conditioning when there is a high likelihood of imminent HEV operation. Together with the monitored charge-state, the SoC-threshold enables prediction or derivation of how much battery power or charge-state is available for temperature conditioning of each, all, and/or some of the HEV components.

Further, power available for pre-conditioning is limited when the external power-signal indicates external power is unavailable. Additionally, preconditioning prioritization may also be needed when a driver action is detected when external power is unavailable, and the detected driver action establishes that a vehicle-start probability exceeds an intent-factor, which intent-factor is derived from past-start-times and associated detected driver actions. The intent-factor may be predetermined as a threshold or comparator that can be utilized to assess the vehicle-start probability, wherein a probability below prevents pre-conditioning and a probability above the intent-factor enables one of full-power or limited power pre-conditioning. The controller(s) may also be configured to control and adjust the preconditioning and the respective conditioning profiles, to increase respective preconditioning rates corresponding to increased power available from one or more of the battery and an external power source.

In other modifications of the HEV of the disclosure, the controller(s) are configured to generate the preconditioning signal including the SoC-threshold and corresponding to the external-power signal, such that preconditioning is prevented. The preconditioning is preferably prevented unless at least one of the external-power signal indicates availability of external power, the charge-state exceeds the SoC-threshold, and/or a driver action is detected that has a vehicle-start probability exceeding an intent-factor, which intent-factor is derived from past-start-times and the corresponding detected driver actions.

Additional variations of the preceding configurations are contemplated that include the controller(s) configured to predict the vehicle start-time according to at least one of an intent-factor defining a vehicle-start probability, and a predicted duration derived from a detected driver action and one or more respective actual and predicted action-to-vehicle-start-times. The action-to-vehicle-start-times may include, for purposes of example, predetermined, estimated, and averages of time spans between a driver action and an actual start that followed such action. Another variation of the disclosure has the controller configured to generate the predicted vehicle start-time from one of the intent-factor and a plurality of past start-times.

The disclosure is also directed to the controller being configured to generate the predicted vehicle start-time from an intent-factor that is derived from one or more of a driver intent-history, and proximity, remote, and vehicle-sensor signals. In still further arrangements, the controller(s) may be further configured to terminate preconditioning upon one of a number of conditions. Such conditions may include, for example without limitation, HEV start, and when the start-time expires without HEV start within a predetermined time-span. Under these termination conditions, the controller(s) may also update a plurality of past start-times with the expired start-time, and a plurality of past intent-factors with an intent-factor. The updates may also include information that indicates the vehicle-start and no-start conditions for each updated item of the respective pluralities.

In various methods of operation of the contemplated HEVs, a method of controlling the HEVs includes commanding by the controller(s), in response to a precondition-signal predicting a start-time, the TMS to precondition temperatures of at least one of the battery, cabin, and catalyst, before the start-time and at a rate according to respective conditioning profiles, and corresponding to the battery charge-state, and the external-power signal. The methods also incorporate commanding by the controller the TMS to precondition temperatures at respective conditioning profile rates, so that the temperature preconditioning is completed by the predicted vehicle start-time.

Modified methods of the disclosure contemplate generating by the controller the preconditioning signal according to the SoC-threshold and the external-power signal, such that the preconditioning signal controls and adjusts the preconditioning and the respective conditioning profiles to increase respective preconditioning rates corresponding to increased power available from one or more of the battery and an external power source. In further adaptations, the methods include, by the controller, terminating preconditioning upon one of the vehicle start, and when the start-time expires without the vehicle start within the predetermined time-span. Also included is updating the plurality of past start-times with the expired start-time, and the plurality of past intent-factors with an intent-factor. The updating preferably indicates one of vehicle-start and no-start conditions.

This summary of the implementations and configurations of the HEVs and described components and systems introduces a selection of exemplary implementations, configurations, and arrangements, in a simplified and less technically detailed arrangement, and such are further described in more detail below in the detailed description in connection with the accompanying illustrations and drawings, and the claims that follow.

This summary is not intended to identify key features or essential features of the claimed technology, nor is it intended to be used as an aid in determining the scope of the claimed subject matter. The features, functions, capabilities, and advantages discussed here may be achieved independently in various example implementations or may be combined in yet other example implementations, as further described elsewhere herein, and which may also be understood by those skilled and knowledgeable in the relevant fields of technology, with reference to the following description and drawings.

### BRIEF DESCRIPTION OF THE DRAWINGS

A more complete understanding of example implementations of the present disclosure may be derived by referring to the detailed description and claims when considered with the following figures, wherein like reference numbers refer to similar or identical elements throughout the figures. The figures and annotations thereon are provided to facilitate understanding of the disclosure without limiting the breadth, scope, scale, or applicability of the disclosure. The drawings are not necessarily made to scale.

FIG. 1 is an illustration of a hybrid electric vehicle and its systems, components, sensors, actuators, and methods of operation;

FIG. 2 illustrates certain aspects of the disclosure depicted in FIG. 1, with components removed and rearranged for purposes of illustration;

FIG. 3 illustrates additional aspects and capabilities of the vehicle and systems and methods of FIGS. 1 and 2, with certain components removed and rearranged for further purposes of illustration; and

FIG. 4 depicts other aspects of the vehicle systems and methods of the preceding figures and describes various additional capabilities of the contemplated vehicle or vehicles and other operational capabilities of the disclosure.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

As those of ordinary skill in the art should understand, various features, components, and processes illustrated and described with reference to any one of the figures may be combined with features, components, and processes illustrated in one or more other figures to enable embodiments that should be apparent to those skilled in the art, but which may not be explicitly illustrated or described. The combinations of features illustrated are representative embodiments for typical applications. Various combinations and modifications of the features consistent with the teachings of this disclosure, however, could be desired for particular applications or implementations, and should be readily within the knowledge, skill, and ability of those working in the relevant fields of technology.

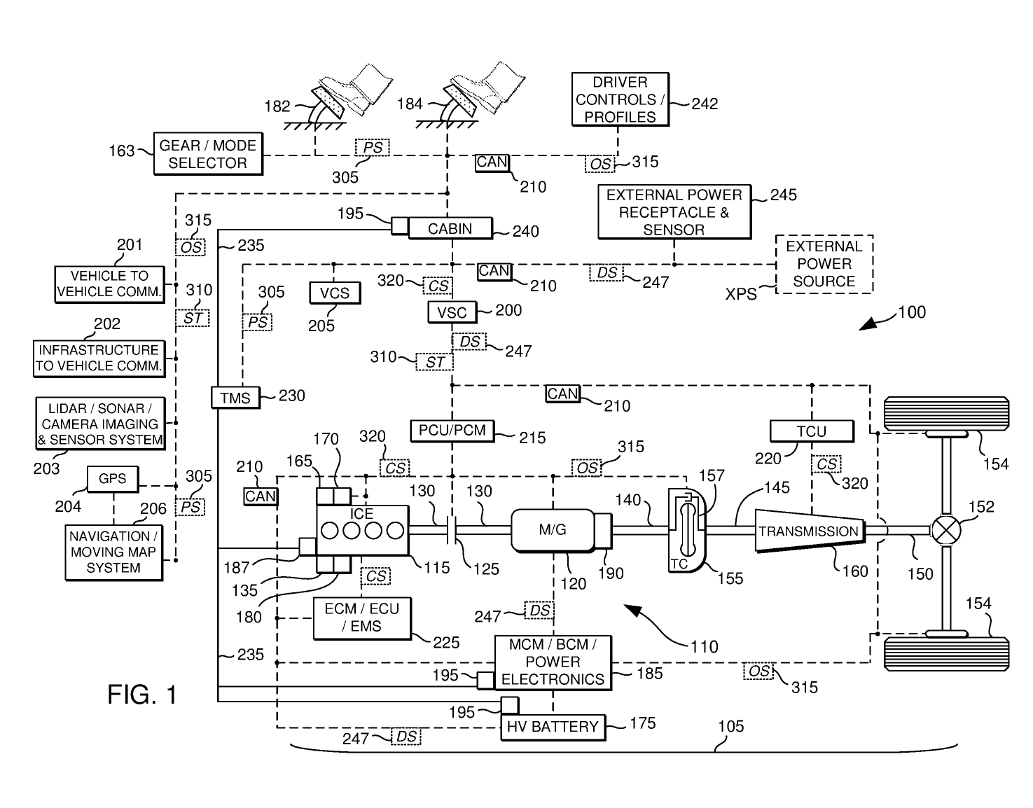

With reference now to the various figures and illustrations and to FIGS. 1, 2, 3, and 4, and also specifically to FIG. 1, a schematic diagram of a hybrid electric vehicle (HEV) 100 is shown, and illustrates representative relationships among components of HEV 100, which can also be a battery electric vehicle (BEV), a plug-in hybrid electric vehicle (PHEV), and combinations and modifications thereof, which are herein collectively referred to as an “HEV”. Physical placement and orientation of the components within vehicle 100 may vary. Vehicle 100 includes a driveline 105 that has a powertrain 110, which includes an internal combustion engine (ICE) 115 and an electric machine or electric motor/generator/starter (M/G) 120, which generate power and torque to propel vehicle 100. Engine or ICE 115 is a gasoline, diesel, biofuel, natural gas, or alternative fuel powered engine, or a fuel cell, which generates an output torque in addition to other forms of electrical, cooling, heating, vacuum, pressure, and hydraulic power by way of front end engine accessory devices (FEADs) described elsewhere herein. ICE 115 is coupled to electric machine or M/G 120 with a disconnect clutch 125. ICE 115 generates such power and associated engine output torque for transmission to M/G 120 when disconnect clutch 125 is at least partially engaged.

M/G 120 may be any one of a plurality of types of electric machines, and for example may be a permanent magnet synchronous motor, electrical power generator, and engine starter 120. For example, when disconnect clutch 125 is at least partially engaged, power and torque may be transmitted from engine 115 to M/G 120 to enable operation as an electric generator, and to other components of vehicle 100. Similarly, M/G 120 may operate as a starter for engine 115 with disconnect clutch 125 partially or fully engaged to transmit power and torque via disconnect clutch drive shafts 130 to engine 115 to start engine 115, in vehicles that include or do not include an independent engine starter 135.

Further, M/G or electric machine 120 may assist engine 115 in a “hybrid electric mode” or an “electric assist mode” by transmitting additional power and torque to turn drive shafts 130 and 140. Also, M/G 120 may operate in an electric only mode wherein engine 115 is decoupled by disconnect clutch 125 and which may be shut down, enabling M/G 120 to transmit positive or negative (reverse) mechanical torque to M/G drive shaft 140 in forward and reverse directions. When in a generator mode, M/G 120 may also be commanded to produce negative electrical torque (when being driven by ICE 115 or other drivetrain elements) and to thereby generate electricity for charging batteries and powering vehicle electrical systems, and while ICE 115 is generating propulsion power for vehicle 100. M/G 120 also may enable regenerative braking when in generator mode by converting rotational, kinetic energy from powertrain 110 and/or wheels 154 during deceleration, into negative electrical torque, and into regenerated electrical energy for storage, in one or more batteries 175, 180, as described in more detail below.

Disconnect clutch 125 may be disengaged to enable engine 115 to stop or to run independently for powering engine accessories, while M/G 120 generates drive power and torque to propel vehicle 100 via M/G drive shaft 140, torque convertor drive shaft 145, and transmission output drive shaft 150. In other arrangements, both engine 115 and M/G 120 may operate with disconnect clutch 125 fully or partially engaged to cooperatively propel vehicle 100 through drive shafts 130, 140, 150, differential 152, and wheels 154. Each or any such components may also be combined in part and/or entirely in a comparable transaxle configuration (not shown). Driveline 105 may be further modified to enable regenerative braking from one or any or all wheel(s) 154, using a selectable and/or controllable differential torque capability. Although FIG. 1 schematically depicts two wheels 154, the disclosure contemplates drive line 105 to include additional wheels 154.

The schematic of FIG. 1 also contemplates alternative configurations with more than one engine 115 and/or M/G 120, which may be offset from drive shafts 130, 140, and where one or more of engines 115 and M/Gs 120 are positioned in series and/or in parallel elsewhere in driveline 105, such as between or as part of a torque convertor and a transmission, and/or a transaxle, off-axis from the drive shafts, and/or elsewhere and in other arrangements. Still other variations are contemplated without deviating from the scope of the present disclosure. Driveline 105 and powertrain 110 also include a transmission that includes a torque convertor (TC) 155, which couples engine 115 and M/G 120 of powertrain 110 with and/or to a transmission 160. TC 155 may further incorporate a bypass clutch and clutch lock 157 that may also operate as a launch clutch, to enable further control and conditioning of the power and torque transmitted from powertrain 110 to other components of vehicle 100. Transmission 160 may also incorporate a gear selector or transmission mode selector 163 (FIG. 1).

In other variations, an emission control device 165 may be coupled with ICE 115, and may include one or more subsystems such as an emissions reducing catalyst, as well as a catalyst and/or ICE heater 170, which when heated to a catalyst and/or ICE 115 operating temperature, enables improved combustion efficiency of ICE 115 and control of emissions therefrom. Catalyst and/or ICE heater 170 may be electrically powered by one or more of batteries 175, 180, an ICE mounted device also known as a front end accessory device (FEAD) alternator or generator, M/G 120, or other components. Powertrain 110 and/or driveline 105 further include one or more batteries 175, 180, as well as drivetrain actuators such as brake pedal and position/accelerometer sensors 182 and accelerator pedal/position/accelerometer sensors 184.

One or more such batteries can be a higher voltage, direct current battery or batteries 175 operating in ranges between about 48 to 600 volts, and sometimes between about 140 and 300 volts or more or less, which is/are used to store and supply power for M/G 120 and during regenerative braking for capturing and storing energy, and for powering and storing energy from other vehicle components and accessories. Other batteries can be a low voltage, direct current battery(ies) 180 operating in the range of between about 6 and 24 volts or more or less, which is/are used to store and supply power for starter 135 to start engine 115, and for other vehicle components and accessories.

Batteries 175, 180 are respectively coupled to engine 115, M/G 120, and vehicle 100, as depicted in FIG. 1, through various mechanical and electrical interfaces and vehicle controllers, as described elsewhere herein. High voltage M/G battery 175 is also coupled to M/G 120 by one or more of a motor control module (MCM), a battery control module (BCM), and/or power electronics 185, which are configured to convert and condition direct current (DC) power provided by high voltage (HV) battery 175 for M/G 120. MCM/BCM/power electronics 185 are also configured to condition, invert, and transform DC battery power into three phase alternating current (AC) as is typically required to power electric machine or M/G 120. MCM/BCM 185/power electronics is also configured to charge one or more batteries 175, 180 with energy generated by M/G 120 and/or front end accessory drive components, and to receive, store, and supply power from and to other vehicle components as needed.

Vehicle 100 may also incorporate one or more refrigerant compressors 187, which may be an ICE-mounted front end accessory device, and/or an electrically driven and/or operated device mounted on or about the ICE 115 or elsewhere on HEV 100, for example such as about M/G 120 to be powered thereby. Cooperatively coupled to the compressor(s) 187, at least one chiller 190 may also be incorporated to enable heat exchange between refrigerant from the compressor(s) 187 and other components. As with the compressor(s) 187, the chiller(s) 190 may be ICE-mounted as a front end accessory, mounted about M/G 120 whereby integral pumps are driven thereby, or elsewhere about HEV 100. Heat exchangers such as evaporators 195 may be coupled with one or more of the compressor(s) 187 and the chiller(s) 190 to enable heat exchange with passenger compartments of HEV 100, battery(ies) 175, 180, MCM/BCM/power electronics 185, and other vehicle components that may require heating and/or cooling.

With continued reference to FIG. 1, vehicle 100 further includes one or more controllers and computing modules and systems, in addition to MCM/BCM/power electronics 185, which enable a variety of vehicle capabilities. For example, vehicle 100 may incorporate a vehicle system controller (VSC) 200 and a vehicle computing system (VCS) and controller 205, which are in communication with MCM/BCM 185, other controllers, and a vehicle network such as a controller area network (CAN) 210, and a larger vehicle control system and other vehicle networks that include other micro-processor-based controllers as described elsewhere herein. CAN 210 may also include network controllers in addition to communications links between controllers, sensors, actuators, and vehicle systems and components. VCS 205 may be configured with one or more communications, navigation, and other sensors, such as a vehicle to vehicle communications system (V2V) 201, and roadway infrastructure to vehicle communication system (I2V) 202, a LIDAR/SONAR (light and/or sound detection and ranging) and/or video camera roadway proximity imaging and obstacle sensor system 203, a GPS or global positioning system 204, and a navigation and moving map display and sensor system 206. The VCS 205 can cooperate in parallel, in series, and distributively with VSC 200 and other controllers to manage and control the vehicle 100 in response to sensor and communication signals identified, established by, communicated to, and received from these vehicle systems and components.

While illustrated here for purposes of example, as discrete, individual controllers, MCM/BCM 185, VSC 200 and VCS 205 may control, be controlled by, communicate signals to and from, and exchange data with other controllers, and other sensors, actuators, signals, and components that are part of the larger vehicle and control systems, external control systems, and internal and external networks. The capabilities and configurations described in connection with any specific micro-processor-based controller as contemplated herein may also be embodied in one or more other controllers and distributed across more than one controller such that multiple controllers can individually, collaboratively, in combination, and cooperatively enable any such capability and configuration. Accordingly, recitation of “a controller” or “the controller(s)” is intended to refer to such controllers both in the singular and plural connotations, and individually, collectively, and in various suitable cooperative and distributed combinations.

Further, communications over the network and CAN 210 are intended to include responding to, sharing, transmitting, and receiving of commands, signals, data, embedding data in signals, control logic, and information between controllers, and sensors, actuators, controls, and vehicle systems and components. The controllers communicate with one or more controller-based input/output (I/O) interfaces that may be implemented as single integrated interfaces enabling communication of raw data and signals, and/or signal conditioning, processing, and/or conversion, short-circuit protection, circuit isolation, and similar capabilities. Alternatively, one or more dedicated hardware or firmware devices, controllers, and systems on a chip may be used to precondition and preprocess particular signals during communications, and before and after such are communicated.

In further illustrations, MCM/BCM 185, VSC 200, VCS 205, CAN 210, and other controllers, may include one or more microprocessors or central processing units (CPU) in communication with various types of computer readable storage devices or media. Computer readable storage devices or media may include volatile and nonvolatile storage in read-only memory (ROM), random-access memory (RAM), and non-volatile or keep-alive memory (NVRAM or KAM). NVRAM or KAM is a persistent or non-volatile memory that may be used to store various commands, executable control logic and instructions and code, data, constants, parameters, and variables needed for operating the vehicle and systems, while the vehicle and systems and the controllers and CPUs are unpowered or powered off. Computer-readable storage devices or media may be implemented using any of a number of known memory devices such as PROMs (programmable read-only memory), EPROMs (electrically PROM), EEPROMs (electrically erasable PROM), flash memory, or any other electric, magnetic, optical, or combination memory devices capable of storing and communicating data.

With attention invited again to FIG. 1, vehicle 100 also may include VCS 205 to be the SYNC onboard vehicle computing system manufactured by the Ford Motor Company (See, for example, U.S. Pat. No. 9,080,668). Vehicle 100 also may include a powertrain control unit/module (PCU/PCM) 215 coupled to VSC 200 or another controller, and coupled to CAN 210 and engine 115, M/G 120, and TC 155 to control each powertrain component. A transmission control unit (TCU) 220 is also coupled to VSC 200 and other controllers via CAN 210, and is coupled to transmission 160 and also optionally to TC 155, to enable operational control. An engine control module (ECM) or unit (ECU) or energy management system (EMS) 225 may also be included having respectively integrated controllers and be in communication with CAN 210, and is coupled to engine 115 and VSC 200 in cooperation with PCU 215 and TCU 220 and other controllers.

In this arrangement, VSC 200 and VCS 205 cooperatively manage and control the vehicle components and other controllers, sensors, and actuators. For example, the controllers may communicate control commands, logic, and instructions and code, data, information, and signals to and/or from engine 115, disconnect clutch 125, M/G 120, TC 155, transmission 160, batteries 175, 180, and MCM/BCM/power electronics 185, and other components and systems. The controllers also may control and communicate with other vehicle components known to those skilled in the art, even though not shown in the figures. The embodiments of vehicle 100 in FIG. 1 also depict exemplary sensors and actuators in communication with vehicle network and CAN 210 that can transmit and receive signals to and from VSC 200, VCS 205, and other controllers.

For further example, various other vehicle functions, actuators, and components may be controlled by the controllers within the vehicle systems and components, and may receive signals from other controllers, sensors, and actuators, which may include, for purposes of illustration but not limitation, front-end accessory drive (FEAD) components and various sensors for battery charging or discharging, including sensors for detecting and/or determining the maximum charge, charge-state or state-of-charge (SoC), and discharge power limits, external environment ambient air temperature (TMP) and cabin and component temperatures, voltages, currents, and battery discharge power and rate limits, and other components. Sensors communicating with the controllers and CAN 210 may, for further example, establish or indicate engine coolant temperature (ECT), accelerator pedal position sensing (PPS), brake pedal positon sensing (BPS), ignition switch position (IGN), transmission mode select levers, car door and trunk position sensors, seat weight sensors, occupant restraint system sensors, barometric pressure, engine and thermal management system and compressor and chiller pressures and temperatures, pump flow rates and pressures and vacuums, exhaust gas oxygen (EGO) or other exhaust gas component concentration or presence, intake mass air flow (MAF), transmission gear, ratio, or mode, and deceleration or shift mode (MDE), among others.

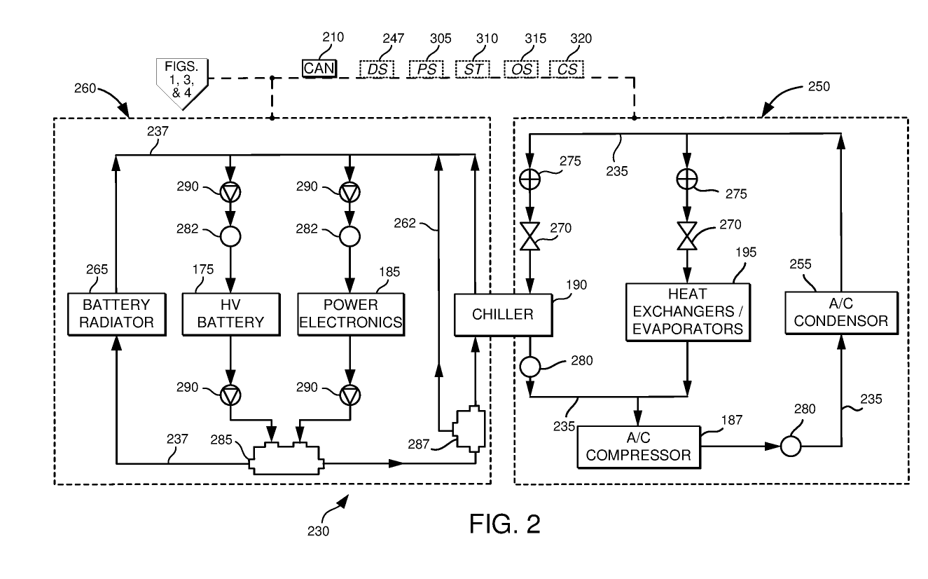

With continuing reference to the various figures, especially now FIGS. 1 and 2, the disclosure contemplates HEV 100 including ICE 115 coupled with electric machine or M/G 120 and high-voltage (HV) storage battery 175 and MCM/BCM/power electronics 185. At least one of an engine mounted and/or an electrically operated refrigerant compressor 187 and/or chiller 190 are incorporated, and each are configured having respective cooling capacities (CC) and form and are coupled to refrigerant and coolant distribution and thermal management system (TMS) 230. The TMS 230 includes refrigerant lines 235 and coolant lines 237, which communicate refrigerant and coolant between compressor 187 and chiller 190, and the heat exchangers and/or evaporators 195 located about a passenger cabin 240 and HV battery 175 and power electronics 185.

HEV 100 and TMS 230 also include one or more controllers coupled to these and other HEV components. Such controllers, including for example, those incorporated with power electronics 185 are configured to charge the battery(ies), and to adjust and control a charge-rate and charge-time therefor, and to discharge and deliver power from the battery(ies). These controller(s), including for example those included with TMS 230, manage distribution of CC to control the temperatures of the cabin 240, and HV battery 175 and coupled power electronics 185.

The temperatures and charge-rate are controlled according to cooling needs (CNs) established from an ambient temperature within and external to the HEV, a predetermined cabin temperature and charge-rate and charge-time, as well as various instantaneous temperatures of other HEV components, including cabin 240, battery 175, and power electronics 185. Such CCs and CNs and other climate control system (CCS) settings and parameters, including driver settings preferences, may be captured and stored in, and communicated from a repository of driver controls and profiles 242. Such controllers, including for example TMS 230, ECU/EMS 225, and others may also control CNs and heating needs of ICE 115 and/or catalyst 165.

HEV 100 also includes at least one external power source receptacle and sensor 245, which is coupled with the various controllers, including for example BCM/MCM/power electronics 185 and HV battery 175. Receptacle 245 is utilized when HEV 100 is stationary and parked adjacent to an external power source (XPS) (FIG. 1), such as in a home, office, or other electrical power charging station or location. These controllers are configured to detect the presence of XPS when it is connected to receptacle 245, and to initiate a charging of HV battery 175, battery 180, as well as enabling power to be supplied to HEV 100 for heater for warming ICE 115 and catalyst 165, and for chiller 190 for cooling battery 175 and power electronics 185 and other TMS 230 components.

Such controllers may also enable bidirectional communication between HEV 100 and external XPS to establish power capacity, cost of power, power use authorization, compatibility, and other parameters and information about and from the external XPS. Such communications between HEV 100 and external XPS may enable automated purchase of power for a period of time, and may enable communication between external XPS and VSC 200 and VCS 205. This configuration may enable an occupant of HEV 100 to interact to convey power purchase authorization via a display in HEV 100. Additionally, HEV 100 may autonomously interact with both external XPS and one or more of VSC 200 and VCS 205 to communicate information to enable automated charging of HEV 100.

With continued reference to the various figures and specifically now also to FIG. 2, additional details of TMS 230 schematically depict the contemplated HEV 100 thermal management system to have a cooling capacity (CC) designed to manage the heating and cooling needed to operate HEV 100. Although the disclosure primarily describes various cooling capabilities, for purposes of illustration, those knowledgeable in the relevant fields of technology should understand that TMS 230 is configured to enable both cooling and heating of various components of HEV 100, including for example, batteries 175, 180, emission aftertreatment system 165 and ICE and/or catalyst heater 170, cabin 240, and other vehicle components. It may be understood that FIG. 2 primarily depicts the cooling components of TMS 230. However, those skilled in the technology should appreciate with reference also to FIG. 1, that fluid and electric heating capabilities are also enabled and contemplated, and include for example without limitation, the exemplary ICE and/or catalyst heater 170, among other heating components, which may cooperate with TMS 230 and other controllers to warm and heat various components, such as heat exchangers 195 of cabin 240, and others.

TMS 230 is typically configured to also include at least one refrigerant circuit 250 that may use a refrigerant such as R134a, and which may include refrigerant lines 235 coupling air conditioning (A/C) compressor 187 with an A/C condenser 255, heat exchangers/evaporators 195, and chiller 190, among other components. TMS 230 also may usually include at least one coolant circuit 260 (in addition to and/or in cooperation with any coolant circuit included with ICE 115), which may use a coolant similar to any of a number of commonly available ICE antifreeze coolants, and configured to heat and/or cool one or more non-ICE 115 components. Coolant circuit 260 may further incorporate coolant lines 237 coupling chiller 190 with one or more non-ICE components, including for example at least one of HV battery 175, BCM/MCM/power electronics 185, and a battery/power electronics radiator 265, among other components.

The TMS 230 may further incorporate various sensors, pumps, and valves, and can include for example, one or more thermal expansion valves 270 and/or solenoid operated valves 275 incorporated about refrigerant circuit 250 and coupled to refrigerant lines 235 and heat exchangers/evaporators 195 and chiller 190. Both refrigerant circuit 250 and coolant circuit 260 may incorporate temperature and pressure sensors 280, and temperature sensors 282, at various locations about refrigerant lines 235 and coolant lines 237, along with electrically actuated and driven multiple-position valves 285 that switch flow between outputs, proportional valves 287 that enable differential flow to multiple outputs, and pumps 290, positioned and configured to control coolant and refrigerant flow and flow rates.

The various valves and pumps may also be included and utilized for configurations where the chiller 190 may be utilized for heat transfer between heat exchangers/evaporators 195, cabin 240, and other components of coolant circuit 260. In further arrangements, coolant circuit 260 may include a chiller bypass coolant line 262, which may enable proportional flow with proportional valve 287 between bypass line 262 and chiller 190, for coolant circuit 260 operations during heating/cooling when refrigerant circuit 250 is unavailable or otherwise unneeded, and for chiller cooling via radiator 265.

To enable charging of the HV battery 175 and/or other batteries, one or more of the controllers, such as those included with BCM/MCM/power electronics 185 are configured to detect external XPS being connected to receptacle 245, and to generate and communicate an external-power signal or direct-current charge-signal (DS) 247, which may include earlier described information indicating connection to XPS, power available from XPS, cost of such power, compatibility data, and use-authorization and authentication data, and related information. In response, the power electronics 185 and/or other controllers initiate charging at a charge-rate of the battery(ies) 175, 180 or others. Typically, the charge-rate is predetermined when HEV 100 is manufactured, as is the charge-time, which is a function of the state-of-charge (SoC) of the respective battery(ies). Both the predetermined charge-rate and the charge-time may be automatically changed by the controllers during normal use as possible life-cycle and performance changes occur in charge capacity and power transfer capability, which the controllers detect in battery 175 and power electronics 185.

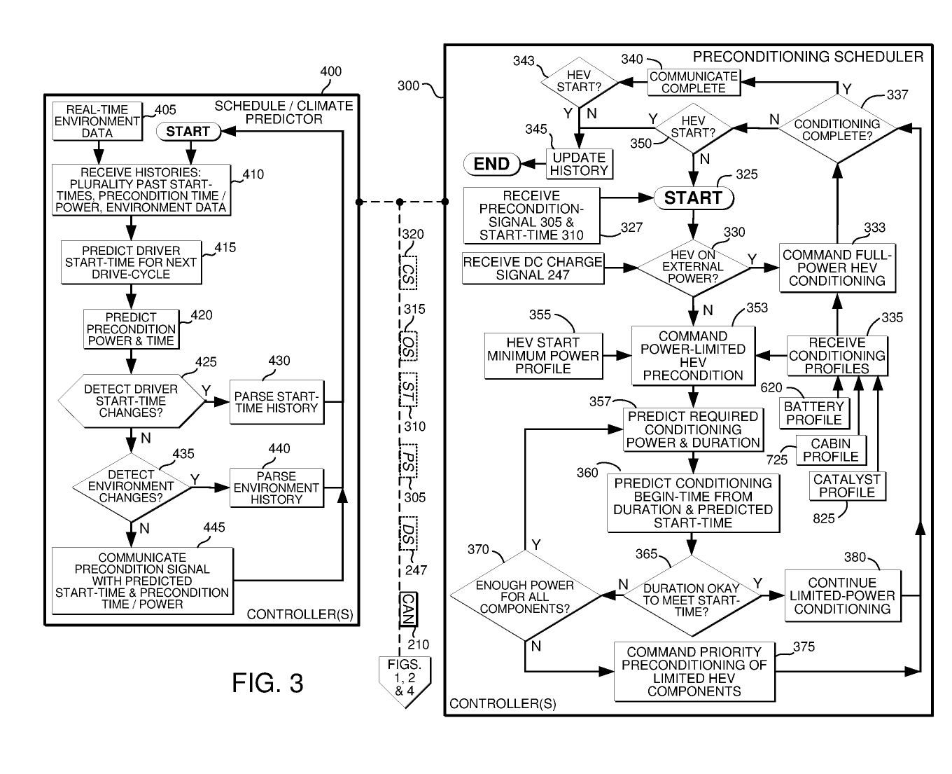

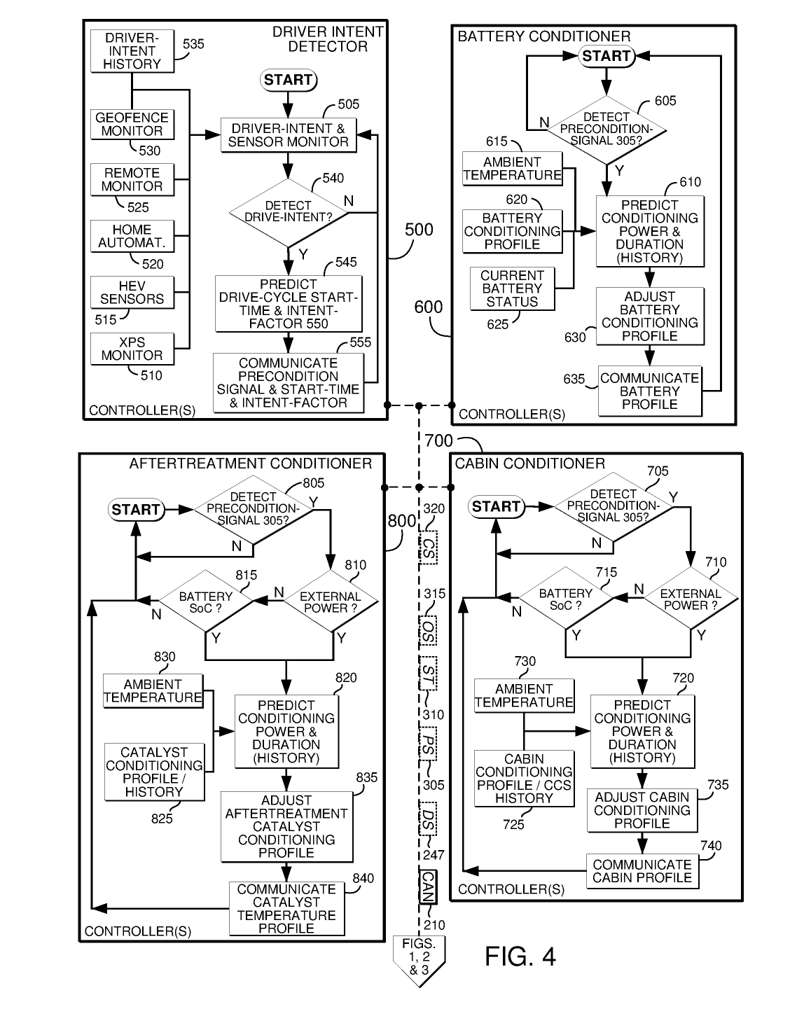

With continued reference to the various figures and now also to FIGS. 3 and 4, it should be understood by those knowledgeable in the field of technology that HEV 100 may be configured to predictively and adaptively precondition temperatures of various components to enable improved efficiency and performance upon start-up and initial operation. Such temperature preconditioning may be directed to any components, and for example without limitation may be configured to precondition the batteries 175, 180, cabin 240, ICE 115, and emissions aftertreatment catalyst 165, among other components. The disclosure contemplates the various controllers to enable the preconditioning by utilizing a preconditioning scheduler 300, that is in communication with and coupled to a schedule/climate predictor 400 and a driver intent detector 500, as well as a battery conditioner 600, a cabin conditioner 700, and an aftertreatment conditioner 800, among others that may be utilized to enable conditioning of other components.

The HEV 100 may be configured such that the preconditioning scheduler 300 initiates and controls component preconditioning, upon generating and/or receiving a precondition-signal (PS) 305 from one or more other controllers and/or sensors. For example, one or more controllers such as the schedule/climate predictor 400 and the driver intent detector 500 may monitor various parameters, and past, recent, and present driver behavior patterns, and HEV controllers and sensors, and generate one or more PSs 305. In this configuration, schedule/climate predictor 400 may generate the PS 305 when a start-time (ST) 310 for HEV 100 is predicted in view of past driver behavior, that evidences a likelihood of HEV start-up at a certain time of day on a certain day of the week. Additionally, the driver intent detector 500 may also generate the PS 305 when ST 310 for HEV 100 is predicted in view of one or more detected driver actions that have a probability of generating a start-time, which may include, for example without limitation, driver proximity to and/or movement towards HEV 100, removal or connection of XPS to HEV 100, actuation of components of HEV 100 such as a restraint system or driver weight on a seat, or other actions.

As described and illustrated in the various figures, including FIGS. 1, 2, 3, and 4, the signals and data, including for example, external-power signal DS 247, PS 305, and predicted start-time 310, and related control logic and executable instructions and other signals, and data can also include other signals (OS) 315, and control or command signals (CS) 320 received from and sent to and between controllers and vehicle components and systems. The external-power signal DS 247, PS 305, start-time 310, OS 315, and CS 320 may be predicted, generated, established, communicated, to, from, and between any of the vehicle controllers, sensors, actuators, components, and systems signals. Any and/or all of these signals can be raw analog or digital signals and data, or preconditioned, preprocessed, combination, and/or derivative data and signals generated in response to other signals, and may represent and be represented by voltages, currents, capacitances, inductances, impedances, and digital data representations thereof, as well as digital information that embeds such signals, data, and analog, digital, and multimedia information.

The communication and operation of the described signals, commands, control instructions and logic, and data and information by the various contemplated controllers, sensors, actuators, and other vehicle components, may be represented schematically as shown in FIGS. 1, 2, 3, and 4, and by flow charts or similar diagrams as exemplified in the methods of the disclosure illustrated specifically in FIGS. 3 and 4. Such flow charts and diagrams illustrate exemplary commands and control processes, control logic and instructions, and operation strategies, which may be implemented using one or more computing, communication, and processing techniques that can include real-time, event-driven, interrupt-driven, multi-tasking, multi-threading, and combinations thereof. The steps and functions shown may be executed, communicated, and performed in the sequence depicted, and in parallel, in repetition, in modified sequences, and in some cases may be combined with other processes and/or omitted. The commands, control logic, and instructions may be executed in one or more of the described microprocessor-based controllers, in external controllers and systems, and may be embodied as primarily hardware, software, virtualized hardware, firmware, virtualized hardware/software/firmware, and combinations thereof.

With specific reference also to FIG. 3, the preconditioning scheduler 300 starts preconditioning HEV 100 at step 325, upon receiving at step 327 the PS 305 and predicted future start-time 310. The scheduler 300 next monitors at step 330 to detect whether HEV 100 is connected to the external power source XPS via external-power signal DS 247 or another signal. If power from XPS is available, then at step 333, depending upon an amount of available XPS power, full-power conditioning of HEV 100 may be commanded, which may include temperature preconditioning of battery(ies) 175, 180, cabin 240, ice 115 and/or catalyst 165 via heater 170, and other components. As explained elsewhere herein, full-power preconditioning is enabled utilizing temperature conditioning profiles that proscribe temperature conditioning power, rate, duration, and target or optimal operating temperature of temperature range for each component being preconditioned. Such temperature conditioning profiles may include, for purposes of illustration, battery profile 620, cabin profile 725, and emissions aftertreatment or catalyst profile 825 (FIGS. 3 and 4), which are received at step 335 for batteries 175, 180, cabin 240, catalyst 165, and other components. As described elsewhere herein, the profile proscribed power, rate, target-temperature(s), and duration may be predetermined, and may be adjusted corresponding to the available power from XPS and the battery(ies) 175, 180 and their respective charge-state(s).

Component conditioning is monitored at step 337 to detect when target/optimal temperatures are attained and preconditioning is complete. If completed, then completion is communicated at step 340. Further, monitoring for an actual start of HEV 100 is detected at 343 and recorded at step 345 to store a plurality of historical start-times 310 and various event data, including for example whether an actual start occurred as predicted, or not. A detected HEV start 343 may terminate temperature preconditioning, even if incomplete. If temperature conditioning is not completed 337, then scheduler 300 again monitors whether an actual start of HEV 100 has occurred yet at step 350, and if so, then preconditioning may be terminated and/or accelerated in favor of nominal post-start operational conditioning, and start-time 310 and related event is also recorded at 345. If preconditioning has not completed and an actual start of HEV 100 has not occurred, then preconditioning continues at 325, as described above.

If XPS is not connected, or external power is limited or is not available, even though XPS is connected, or, XPS power is incompatible or unauthorized for use, as monitored at step 330, then power-limited preconditioning of HEV 100 is enabled at step 353, again utilizing the profiles 620, 725, 825, which are received at 335. During the power-limited preconditioning, only some amount of XPS and/or internal power from battery(ies) 175, 180 may be available for temperature preconditioning purposes. Consequently, a state-of-charge (SoC) of the battery(ies) 175, 180 must be detected. Further, a minimum power profile for start of HEV 100 is needed and received at step 355, to establish how much power may be needed to start HEV 100 after such preconditioning is completed, to ensure that sufficient SoC remains in battery(ies) 175, 180 to complete both preconditioning and subsequent start of HEV 100.

Next, preconditioning scheduler 300 derives at step 357 from the preceding profiles and the SoC, PS 305, XPS power availability and start-time 310, how much conditioning power is needed and for what duration to both precondition the various components of HEV 100 and to enable post-conditioning start of HEV 100. It is further then derived at step 360 when temperature preconditioning must begin as a function of the duration and other parameters to ensure such components reach optimum operating temperatures by the predicted start-time 310.

The scheduler 300 may also monitor at step 365 whether the derived duration will enable temperature preconditioning to be completed by the predicted start-time 310. If the derived duration is too long, then scheduler 300 may then detect whether enough power is available at step 370, and if so, scheduler 300 may then make adjustments and re-predict and adjust required conditioning power and the duration at step 357 to increase power for conditioning to meet ST 310.

If not enough power is available at step 370, then scheduler 300 will enable prioritization and/or priority temperature preconditioning at step 375 according to the profiles 620, 725, 825, and may partially and/or fully condition one or a combination of components of HEV 100, and for example may temperature precondition only battery(ies) 175, 180. For further illustration purposes, scheduler 300 also may not precondition cabin 240, catalyst 165, or other components, and/or may partially/fully precondition other or some components that require less power, or may prevent preconditioning of any, all, or other components to ensure power is available to start HEV 100, and to perhaps temperature precondition only those components that may be predetermined to be essential and/or required, and combinations thereof.

In additional examples, limited power preconditioning may be enabled when the charge-state of the battery(ies) 175, 180, is/are approximately less than or equal to a battery state-of-charge-threshold (SoC-threshold) plus some amount of additional power needed to power the contemplated preconditioning. The SoC-threshold may be predetermined to specify a minimum battery charge-state, below which the stored battery power is less than what may be needed to otherwise enable HEV start and pre-conditioning, when external power from XPS is unavailable. The SoC-threshold may also proscribe a battery charge-state above which the stored battery power is sufficient to enable HEV start and/or full or limited pre-conditioning when there is a high likelihood of imminent HEV operation.

During limited power preconditioning, scheduler 300 will continue to monitor for completed preconditioning, and may continue to cycle through one or more of the preceding temperature preconditioning operations. Alternatively, if at step 365, the duration is detected to be sufficient to meet the predicted start-time 310, then scheduler 300 will continue limited-power conditioning at step 380, and monitor for completion.

With continued and specific reference to FIG. 3, the preconditioning scheduler 300 communicates with the other controllers, including for further illustration, schedule/climate predictor 400, which enables additional capabilities directed to predicting the start-time 310 by monitoring current and/or real-time environment data 405, by receiving and storing histories, at step 410, of past start-times 310 and related start and no-start preconditioning event power and duration data. The real-time environment data 405 may include generalized seasonal and geographic climate data such as temperature and humidity, and which can also include and/or enable adjusted profiles for changes due to warmer and cooler seasonal, geographical, and weather-related temperature and humidity changes.

Actual current ambient and component temperatures, humidity, and related data may also be communicated, which data can be utilized to determine how much power may be needed to temperature precondition components of HEV 100, and over how long a duration, to achieve pre-start operating temperatures according to the profiles 620, 725, 825. This information is utilized by predictor 400 and analyzed using any number of deep-learning and/or pattern detection and recognition techniques to predict prospective start-times 310 for possibly upcoming drive-cycles, at step 415. Further, the predictor 400 also then derives at step 420 prospective, likely precondition power and duration for the predicted start-time 310, as a function of the past, historical powers and durations of prior preconditioning and actual vehicle start events, and other parameters and data.

The predictor 400 may also further analyze the historical data 410, at step 425, to detect whether recent changes in driver behaviors have occurred, such as new and different actual, past start-times 310, which may influence the start-time 310 being predicted by predictor 400. If recent changes are detected in driver patterns of past start-times 310, the predictor 400 may parse, at step 430, stored historical start-times 310 of the plurality to remove old, non-representative, erroneous, changed, and/or stale data, while retaining more current, changed data. Predictor 400 may then start the temperature preconditioning analysis, deep-learning/pattern recognition prediction cycle again. Alternatively, if no recent changes in driver behaviors are detected at 425, then predictor 400 may then detect at step 435 whether seasonal changes have or are occurring that may change environmental data such as temperature and humidity, daylight savings time, or other preconditioning performance factors. Also, current or actual temperature, humidity may be detected to determine whether environmental changes have occurred that are substantially different than those predicted by seasonal and/or geographic climate and time data.

If such current environmental data is detected at 435, predictor 400 may parse and remove stored historical environment data at step 440 or elsewhere while retaining more current environment patterns of data to improve and/or influence predictive capabilities in view of more recent and possibly more accurate and/or representative and non-anomalous data. Predictor 400 may then restart the prediction routine at step 410. If the schedule/climate predictor 400 does not detect either driver start-time changes 425 or climate/environmental changes 435, then predictor 400 will communicate at step 445 the prediction-signal 305, and continue monitoring real-time and historical data for new predicted temperature precondition-signals 305.

Attention is now also invited to FIG. 4, with continuing consideration of the various figures, wherein it may be understood that preconditioning scheduler 300 also communicates with other controllers that include, for an additional example, driver intent detector 500. The driver intent detector 500 is configured to also predict a start-time 310, but utilizes a driver-intent sensor monitor 505 that is configured to monitor various intra- and extra-vehicular sensors to detect driver actions, movement, and location. Such sensors may include, for purposes of additional illustrations, connection/disconnection XPS sensor or monitor 510, and driver actuation of HEV sensors 515 such as brake and accelerator pedals 182, 184 and gear selector 163, various driver controls like an HEV camera/motion/proximity obstacle sensor 203, sensors from other vehicles 201, infrastructure 202, and sensors 515 that detect status of a trunk, door, seat, restraint, gear lever, brake release, headlights, hazard signal lights, or turn-signal lights, and other HEV components.

Additionally, the sensor monitor 505 of detector 500 also monitors driver location, movement, and relative proximity to HEV 100 by receiving information from home automation sensors 520 such as a home and/or garage entry/exit door sensor, a VCS 205 or an I2V 202 driver location detection capability associated with the VCS 205 (for example, Ford SYNC(™)), a remote monitor 525 that monitors remote control devices such as a car alarm remote, garage door remote, a keyless entry remote and/or RFID device for HEV 100 or for an office or a home, a geofence monitor 530 that receives location and movement data from driver mobile communication devices such as mobile telephones, wearable electronics, and similar mobile devices, and similar sources of data that may indicate a driver intention to start and drive HEV 100.

With the monitored data, the driver-intent and sensor monitor 505 then utilizes driver intent historical data 535, which stores past driver action data and actual, associated start-times 310 and indicators of subsequent startup or non-starts of HEV 100. Such past driver action data and start-times 310, may include for example purposes, one or more past respective actual and predicted action-to-vehicle-start-times. As an additional illustration, the action-to-vehicle-start-times may represent and include predetermined, estimated, and averages of time spans between detected driver actions and an actual previous start of HEV 100 that followed such previously detected driver action. Another variation includes the controller generating the predicted vehicle start-time 310 from one of the intent-factor 550 and an average or deep-learned or recognized pattern assessment of a plurality of associated past start-times 310.

With this data, the driver-intent and sensor monitor 505 predicts at step 545 whether any of the currently detected driver actions represented by the monitor and sensor data 510, 515, 520, 525, 530, indicates and/or predicts whether a driver is likely to approach, enter, and start HEV 100. If not, then monitoring continues by monitor 505. If driver actions predict an intent to start HEV 100, then the detector 500 at step 545 derives the start-time 310 and an intent-factor 550.

The intent-factor 550 includes a probability that the detected driver actions (location, proximity, movement, and other noted actions) indicate that a start-up and drive-cycle of HEV 100 is likely to occur in view of the detected driver actions. Intent-factor 550 is utilized to establish the probability of whether the start-time 310 is imminent and likely to occur. The intent-factor 550 may establish a threshold probability or comparator. For example, an intent-factor 550 probability below a predetermined probability, for example without limitation a probability of 50%, may enable scheduler 300 or another controller to prevent pre-conditioning when the intent-factor 550 is below 50%. A higher intent-factor 550 probability above the exemplary 50% may enable either full-power or limited power pre-conditioning depending upon the other parameters described elsewhere herein. The exemplary 50% may be predetermined at the time of manufacture of HEV 100, and/or may be also adjustable by a driver and/or automatically by the HEV systems and components contemplated herein.

In applications requiring limited power temperature preconditioning, the scheduler 300 may enable prioritization of conditioning between the contemplated components of HEV 100, when a driver action is detected, and the detector 500 determines that the detected action establishes that a vehicle-start probability characterized by intent-factor 550 exceeds some exemplary, desired, predetermined probability such that temperature preconditioning proceeds. The predicted drive-cycle start-time 310 and intent-factor 550 that are established at step 540, are then communicated at step 555 with and/or as part of the precondition-signal 305 to other controllers, including for example preconditioning scheduler 300. The driver-intent detector 500 thereafter may continue monitoring at step 505.

A battery conditioner 600 is another controller that is also illustrated in part in FIG. 4, which enables additional capabilities in cooperation with the other controllers contemplated herein. Battery conditioner 600 monitors at step 605 for the precondition-signal 305, and the related data, predicts a conditioning power needed and a duration from historical data at step 610, and also monitors an ambient temperature 615 of the surrounding environment and the battery(ies) 175, 180, and a battery charge-state or SoC, among other parameters. A battery temperature conditioning profile 620 proscribes optimal battery operating and target temperatures, a minimum state-of-charge-threshold (SoC-threshold), and a rate of conditioning that may be predetermined and adjusted according or corresponding to power available for temperature preconditioning from XPS and the charge-state of battery(ies) 175, 180. Battery conditioning profile 620 may also capture and store accumulated battery performance data such as charge-discharge cycles and current SoCs, maximum charge capacity and minimum SOCs, which may enable prediction of current, future, and changing performance capabilities.

The generated preconditioning signal is generated including a state-of-charge-threshold (SoC-threshold) and corresponding to the external-power signal DS 247, which, with the charge-state, defines how much power between the XPS and the charge-state of the battery(ies) 175, 180, is available to enable pre-conditioning. The SoC-threshold preferably also proscribes a minimum amount of battery power needed to start HEV 100 after preconditioning is completed. The SoC-threshold may also be adjusted to reflect to additional power needed to temperature precondition one or more components of HEV 100 as already described such that when such power has been expended from the battery(ies), enough remains, with a possibly desired margin or reserve of extra power, to start HEV 100. The battery(ies) may supply such preconditioning power at a predetermined temperature conditioning rate according to the profile 620, and as may be adjusted, and according to a current battery status 625 that establishes total battery cycles, maximum SoC, maximum charge and discharge rates, and other pertinent battery life-cycle and performance data. In view of available XPS and battery power, it may be established that only partial temperature preconditioning or conditioning of only some of HEV components may be possible, if at all.

With this data, the battery conditioner 600 then further detects precondition signal 305 at step, predicts a battery temperature conditioning power, rate, duration from a history at step 610, which that is needed to meet requirements of the battery temperature conditioning profile 620, so that the temperature of battery(ies) 175, 180 can be achieved by the predicted start-time 310, if possible. Next, battery conditioner 600 may adjust battery conditioning profile 620 at step 630, to increase or decrease the temperature conditioning rate, and/or may enable only partial preconditioning, in view of ambient temperature and/or a need to increase the rate to meet a fast-approaching start-time 310 or to decrease the conditioning rate to conserve and/or maintain a reserve of battery power, and may store the adjusted profile 620, and then communicated the battery profile 620 at step 635. Thereafter, battery conditioner 600 monitoring may continue at step 605.

With continued reference to FIG. 4, a cabin conditioner 700 is also depicted schematically, which communicates with the other controllers, and is configured at step 705 to monitor for precondition-signal 305 and related data. The cabin conditioner 700 also detects external-power signal DS 247 at step 710 to establish whether HEV 100 is connected to XPS and whether sufficient external power is available for conditioning cabin 240. If not, then cabin conditioner 700 detects at step 715 whether sufficient battery SoC and power is available for cabin conditioning. If not, then cabin conditioner 700 continues monitoring without expending power to temperature precondition cabin 240. Depending upon available XPS and battery power, cabin conditioner 700 may enable partial preconditioning of cabin 240.

If either external power or battery power is available, then cabin conditioner 700 next predicts at step 720 the temperature conditioning power, conditioning rate, and duration needed to enable the cabin to be temperature pre-conditioned according or corresponding to one or more of the available power from XPS and the charge-state of the battery(ies) 175, 180, an ambient temperature 730 of a surrounding environment and the cabin 240, and a cabin conditioning profile 725, a cabin climate system (CCS) history, and/or a driver profile that may include driver profiles 242 including, for example, CCS settings (FIG. 1). With this data, cabin conditioner 700 also then may adjust cabin conditioning profile 725 at step 735, and then communicate the profile at step 740, and thereafter continue monitoring. The cabin conditioning profile 725 may include a predetermined temperature conditioning rate that may be adjusted in view of ambient temperature and other parameters to increase the rate to meet the predicted start-time 310, and to decrease the conditioning rate to conserve power, or for other reasons. The adjusted cabin conditioning profile 725 may also be utilized to adjust the temperature conditioning rate to enable partial conditioning of cabin 240.

An aftertreatment conditioner 800 is shown in FIG. 4, and is coupled and in communication with the other controllers, and enables temperature preconditioning of the catalyst of emission control device 165 by utilizing ICE and/or catalyst heater 170. The conditioner 800 at step 805 monitors for precondition-signal 305 and related data, and then at step 810 detects external-power signal DS 247 to establish availability of external power from XPS. If power is not available, then at step 815, the aftertreatment conditioner 800 detects whether enough battery SoC or power is available to temperature precondition the catalyst 165. If not, then monitoring continues without power being expended for catalyst preconditioning.

If sufficient catalyst preconditioning power is available from either XPS or the battery(ies) 175, 180, then the aftertreatment conditioner 800 predicts at step 820 how much power and how much of a duration is needed to enable temperature preconditioning of the catalyst 165. The power and duration are predicted and derived from an ambient temperature 830 of the environment and the catalyst, as well as a catalyst temperature conditioning profile 825 that proscribes optimum operating and target temperatures of catalyst 165, as well as catalyst temperature conditioning rates that may be adjusted according or corresponding to one or more of the predicted start-time 310, the ambient temperature, and the availability of power from XPS and the charge-state of the battery(ies) 175, 180, for heating catalyst 165, and other parameters. The conditioner 800 then utilizes this various data at step 835 to adjust aftertreatment catalyst conditioning profile 825 if required in view of current conditions, and to store such adjusted profile 825 is desired. Thereafter, at step 840, the catalyst temperature profile 825 is communicated at step 840 to enable full, partial, and/or no preconditioning according to available XPS and battery power, and monitoring may then continue at step 805.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. A vehicle, comprising:
a controller coupled to a thermal management system (TMS), and configured to, in response to a precondition-signal predicting a start-time,
monitor a battery charge-state and an external-power signal, and
command the TMS to precondition temperatures, before the start-time, of at least one of a battery and a cabin,
according to respective conditioning profiles and the charge-state, and
corresponding to the external-power signal.

2. The vehicle according to claim 1, comprising:
the controller further configured to command the TMS to precondition temperatures of at least one of the battery, the cabin, and an aftertreatment catalyst according to the respective conditioning profiles and the charge-state and external-power signal.

3. The vehicle according to claim 2, comprising:
the controller configured to command the TMS to precondition the temperatures at a rate that completes the temperature preconditioning by the predicted start-time.

4. The vehicle according to claim 2, comprising:
the controller configured to generate the preconditioning signal including to a state-of-charge threshold (SoC-threshold) and corresponding to the external-power signal, such that the preconditioning signal controls and prioritizes the temperature preconditioning between the battery, cabin, and catalyst according to the respective conditioning profiles when:
the charge-state is approximately less than or equal to the SoC-threshold,
the external power-signal indicates external power is unavailable, and
a driver action is detected and a vehicle-start probability exceeds an intent-factor that is derived from past-start-times and the detected driver action.

5. The vehicle according to claim 1, comprising:
the controller configured to generate the preconditioning signal including an SoC-threshold and corresponding to the external-power signal, such that the preconditioning signal controls and adjusts the preconditioning and the respective conditioning profiles to increase respective preconditioning rates corresponding to increased power available from one or more of the battery and an external power source.

6. The vehicle according to claim 1, comprising:
the controller configured to generate the preconditioning signal including an SoC-threshold and corresponding to the external-power signal, such that the preconditioning signal controls and adjusts the preconditioning and the respective conditioning profiles to only precondition temperature of the battery when:
the charge-state is approximately less than or equal to the SoC-threshold, and
the external power-signal indicates external power is unavailable.

7. The vehicle according to claim 1, comprising:
the controller configured to generate the preconditioning signal including an SoC-threshold and corresponding to the external-power signal, such that preconditioning is prevented unless at least one of:
the external-power signal indicates availability of external power,
the charge-state exceeds the SoC-threshold, and
a driver action is detected and a vehicle-start probability exceeds an intent-factor that is derived from past-start-times and the detected driver action.

8. The vehicle according to claim 1, comprising:
the controller configured to predict the start-time according to at least one of:
an intent-factor defining a vehicle-start probability, and
a predicted duration derived from a detected driver action and one or more respective actual and predicted action-to-vehicle-start-times.

9. The vehicle according to claim 1, comprising:
the controller configured to generate the predicted start-time from one of an intent-factor and a plurality of past start-times.

10. The vehicle according to claim 1, comprising:
the controller configured to generate the predicted start-time from an intent-factor derived from one or more of driver intent-history, and proximity, remote, and vehicle-sensor signals.

11. The vehicle according to claim 1, comprising:
the controller further configured to:
terminate preconditioning upon one of:
a vehicle start, and
when the start-time expires without a vehicle start within a predetermined time-span, and
update a plurality of:
past start-times with the expired start-time,
past intent-factors with an intent-factor, and
such that the updates indicate one of vehicle-start and no-start conditions.

12. A vehicle, comprising:
a thermal management system (TMS); and
a controller coupled to the TMS, and configured to, in response to a precondition-signal predicting a start-time,
command the TMS to precondition temperatures before the start-time of at least one of a battery and a cabin,
at a rate according to respective conditioning profiles, and
corresponding to a battery charge-state and an external-power signal.

13. The vehicle according to claim 12, comprising:
the controller further configured to command the TMS to precondition temperatures of at least one of the battery, the cabin, and an aftertreatment catalyst according to the respective conditioning profiles and the charge-state and external-power signal.

14. The vehicle according to claim 13, comprising:
the controller configured to command the TMS to precondition the temperatures at respective conditioning profile rates that complete the temperature preconditioning of each of the battery, cabin, and catalyst by the predicted start-time.

15. The vehicle according to claim 12, comprising:
the controller further configured to:
terminate preconditioning upon one of:
a vehicle start, and
when the start-time expires without a vehicle start within a predetermined time-span, and
update a plurality of:
past start-times with the expired start-time,
past intent-factors with an intent-factor, and
such that the updates indicate one of vehicle-start and no-start conditions.

16. A method of controlling a vehicle, comprising:
commanding by a controller, in response to a precondition-signal predicting a start-time,
a thermal management system (TMS) to precondition temperatures of at least one of a battery and a cabin,
before the start-time,
at a rate according to respective conditioning profiles, and
corresponding to a battery charge-state, and an external-power signal.

17. The method according to claim 16, further comprising:
commanding by the controller the TMS to precondition temperatures of at least one of the battery, the cabin, and an aftertreatment catalyst according to the respective conditioning profiles and the charge-state and external-power signal.

18. The method according to claim 16, further comprising:
commanding by the controller the TMS to precondition the temperatures at respective conditioning profile rates that complete the temperature preconditioning by the predicted start-time.

19. The method according to claim 16, further comprising:
generating by the controller the preconditioning signal including an SoC-threshold and corresponding to the external-power signal, such that the preconditioning signal controls and adjusts the preconditioning and the respective conditioning profiles to increase respective preconditioning rates corresponding to increased power available from one or more of the battery and an external power source.

20. The method according to claim 16, further comprising:
by the controller,
terminating preconditioning upon one of:
a vehicle start, and
when the start-time expires without a vehicle start within a predetermined time-span, and
updating a plurality of:
past start-times with the expired start-time,
past intent-factors with an intent-factor, and
such that the updating indicates one of vehicle-start and no-start conditions.
